(19) United States
(12) Patent Application Publication
(10) Pub. No.: US 2006/0135230 A1
(43) Pub. Date: Jun. 22, 2006

(54) Post-deployment spot creation

(76) Inventors: Dhananjay Godse, Kanata (CA); Daniel Willis, Stittsville (CA); Gordon Freedman, Nepean (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 11/300,352

(22) Filed: Dec. 15, 2005

Related U.S. Application Data
(60) Provisional application No. 60/636,114, filed on Dec. 16, 2004.

(51) Int. Cl. A63F 13/00

(52) U.S. Cl. 463/1

(57) ABSTRACT

A thin client is for detecting a video game in execution. The video game does not support dynamic in game advertising. The thin client changes the video game content of the video game during execution thereof in order to provide in game advertising within the first video game in execution.

This application claims benefit from U.S. Provisional Patent Application No. 60/636,114 filed Dec. 16, 2004, the entire contents of which is incorporated herein by reference.

### FIELD OF THE INVENTION

The instant invention generally relates to advertising in games, and more specifically to a method that allows a game producer to introduce new advertising spots after the installation of the video game.

### BACKGROUND

Increasingly, gamers play video games remote to each other using computing devices that share data via the Internet. In addition, the computing devices that support video game sessions have become increasingly more powerful and are therefore capable of providing virtual environments with a substantial degree of realism.

A recent trend that takes advantage of the computing power now available to increase revenue for game providers is to provide advertising in video games. Thus, within a video game session, an advertisement is provided to a gamer. When the computing device that supports the video game, the video game system, is in data communication with a public network, such as the Internet, data corresponding to new and updated advertisements is optionally provided the computing device and stored in a memory of the computing device for integration into a video game advertisement.

Clearly, providing advertisements provides a new stream of revenue for game publishers however it is often the case that the development of the video game is initiated without integrating such advertising spots within a video game. Integrating such advertising spots is an expense and, in some cases, a slow process.

It would be beneficial to provide an alternative method of providing advertising spots within an exeisting video game that does not involve a gamer having to purchase additional software or installing a software patch.

### SUMMARY OF THE INVENTION

In accordance with the instant invention there is provided a method comprising: providing a first video game in execution, the video game other than supporting dynamic in game advertising; and, changing video game content of the first video game during execution thereof in order to provide in game advertising within the first video game in execution

In accordance with the invention there is provided a method comprising: executing video game to provide a video game session supporting a virtual environment with a computing device; loading thin client within a same computing device; identifying an occurrence of a predetermined game event; and, executing thin client in response to the identified occurrence, the thin client for impressing media upon a gamer.

In accordance with the invention there is provided a method comprising: providing a computing device; loading a thin client; loading alternative advertising content; loading video game software, the video game software for supporting a video game session; identifying at least an instance of an advertising spot within the video game session; for each identified instance of an advertising spot identifying a memory location associated with default content associated with the advertising spot; for each identified instance reviewing the alternative advertising content to determine if advertising content is available; and, when advertising content is available writing the advertising content in place of the default content.

In accordance with another embodiment there is provided a method comprising: providing a computing device; providing a game program; executing the game program using the computing device, the game program comprising a software hook for obtaining metadata, the game program for providing a virtual environment; obtaining metadata using the software hook; and, in accordance with the metadata, providing an advertising spot within the virtual environment.

In accordance with another aspect of the invention there is provided a storage medium comprising data stored therein, the data for when executed resulting in execution of: detecting a first video game in execution, the video game other than supporting dynamic in game advertising; and, changing video game content of the first video game during execution thereof in order to provide in game advertising within the first video game in execution.

In accordance with another embodiment there is provided a storage medium comprising data stored therein, the data for when executed resulting in execution of: providing a computing device; providing a game program; executing the game program using the computing device, the game program comprising a software hook for obtaining metadata, the game program for providing a virtual environment; obtaining metadata using the software hook; and, in accordance with the metadata, providing an advertising spot within the virtual environment.

### BRIEF DESCRIPTION OF THE DRAWINGS

The invention is now described with reference to the drawings in which:

FIG. 1 is a diagram of a computing device in data communication with an advertising server;

FIG. 2 is a flowchart describing the operation of a thin client according to a first embodiment of the invention;

FIG. 3 is a flowchart describing the operation of a thin client in which the thin client reserves memory locations where downloaded content is stored, in accordance with a second embodiment of the invention;

FIG. 4 is a flowchart according to method of providing advertising spots within a video game using an application programming interface, the method consistent with a third embodiment of the invention; and,

FIG. 5 is a flowchart according to a fourth embodiment of the invention in which the game program is designed to support integration of new advertising spots.

### DETAILED DESCRIPTION OF THE INVENTION

Typically video games are sold in packages that contain a non-volatile storage media, such as a CD-ROM or DVD. The data on the storage media is fixed and does not change. When it is determined that there is an error or change required to software or data stored on the storage media once the video game has already been widely sold it is common practice to provide a software patch. The software patch provides additional data to the game that serves to overcome the software errors and other unforeseen problems with the video game software. As it is very expensive and impractical for a software publisher to distribute the software patch to each user of the game, it is common practice to provide software patches via Internet servers. Clearly, this is only beneficial for video game systems that have large non-volatile storage media that support storage of instructions. Traditionally, only personal computers had such media however they are becoming increasing common in game consoles as the cost of hard disc drives and flash memory chips fall.

While software patching is an option for introducing new features and content into a video game it is not particularly efficient way of doing so. Typically in order for a user to apply a software patch it is necessary to download the patch, store the patch, decompress the patch and run the patch. These steps are time consuming and annoying. The invention seeks to provide alternative methods of introducing new game content into a video game absent normal interaction from a gamer that plays the video game.

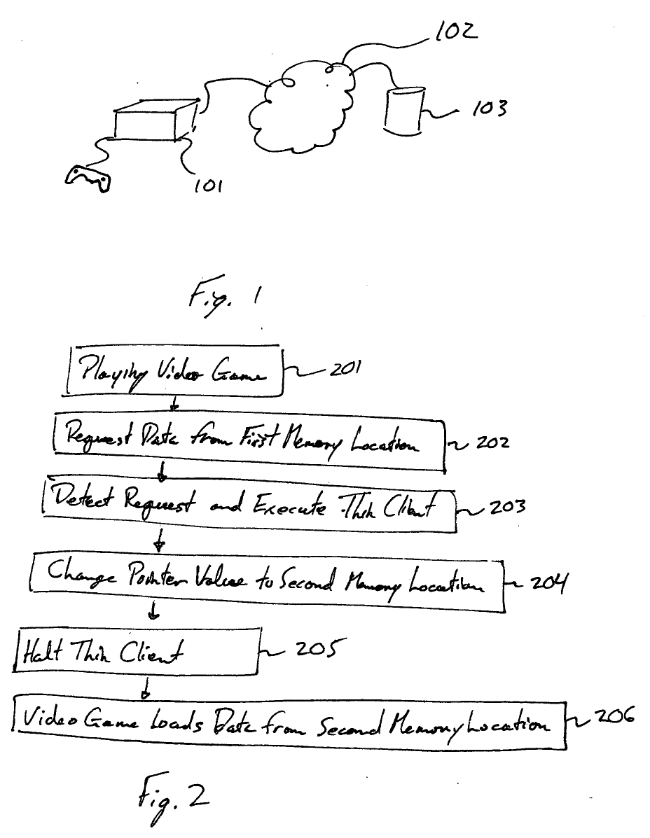

Referring to FIG. 1, a computer gaming system for providing advertising content according to prior art is shown. FIG. 1 illustrates: a computing device 101, a public network 102 and, an advertising server 103. In use, a processor of the computing device 101 executes game software to support the gaming session. The game software comprises instructions to provide an advertising spot. Thus, during a gaming session executed on an online connected platform the advertising spot is provided. When the gaming session is initiated advertising data is downloaded from the advertising server 103 via the public network 102 and stored in a cache memory. In the event that the game software does not support an advertising spot then no advertisement is provided.

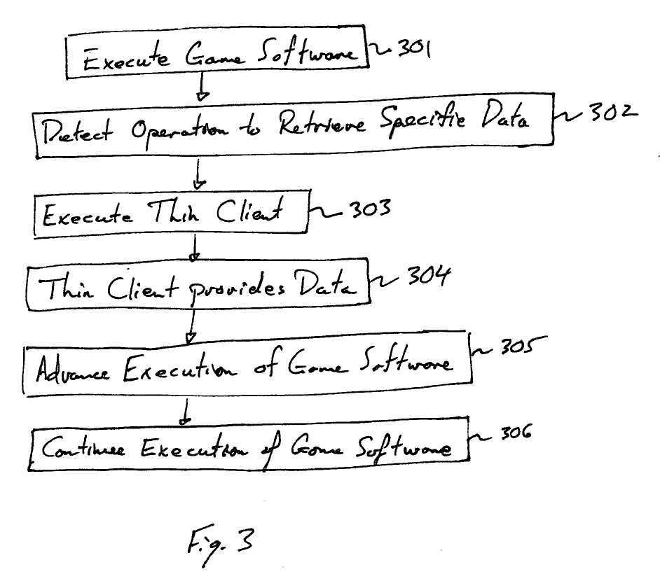

A first embodiment of the invention acts to provide advertising spots within a video game that has not been designed to support advertising spots. This is accomplished by providing a thin client that handles managing of a cache memory used to store content data. During a video game session the game software provides a virtual environment. Typical video games have very detailed virtual environments that often include fake advertising as part of a scene. A variety of objects within the virtual environment have texture data associated with them. The texture data is used to provide a visual representation of a surface. Thus, an object or surface has related texture data. This related texture data is provided as default content. In this way, the video game provides a virtual gaming environment with a set of default surface textures. The thin client detects requests for default content data corresponding to the default surface textures by the game software and redirects the game software to provide alternative surface textures instead. Referring to FIG. 2 a simplified flowchart is shown. The game program is executed 201 and a request for first data from a first memory location within the cache memory is made 202. The game program addresses the cache memory by maintaining a memory pointer. The memory pointer provides the address of the first location in the cache memory. A second process in the form of a thin client is executed 203 when the request for data is detected. While the second process is active the game program execution is delayed. The second process modifies the value of the pointer to indicate a second location within the memory 204. The second process then stops 205 and the game program resumes normal operation from the point where it was suspended. The game program loads data from the memory based upon the current value of the pointer. Thus, the game program loads data from the second memory location 206 instead of the first. A person of skill in the art will appreciate that changing the value of a pointer using a program flow interruption as described with reference to the first embodiment of the invention is straight forward. Specifically, the amount of time used to process the interruption is sufficiently short that gameplay is not affected in a noticeable way. While the embodiment describes the content data as being stored in memory, optionally the content data is stored in a same cache as the default content. Of course, a person of skill in the art will appreciate that the default content and the content data are optionally stored in any of a variety of different memories rapidly accessible to the computing device. Thus, while one might expect the content data and the default content to be stored in a random access memory of the computing device this need not be the case. Specifically, other memories, such as flash memories, hard disc drives and read only memories are optionally used. Optionally, if the second process is unable to identify suitable content data then the second process provides a request to a download manager application that acts to download additional content in a fashion that does not hinder gameplay. Thus, the second process provides new advertisements to the video game in ways that were not previously supported. Optionally, the second process is provided independent of the game program. Thus, after the video game is installed and running on a computing device, the computing device accesses a game server via a public network, such as the Internet, and downloads and stores the second process. The second process is then available for use. Alternatively, the second process is incorporated within the gaming system. A person of skill in the art of programming will appreciate that the second process is optionally provided as a relatively small program that is stored in a relatively small amount of memory.

Normal operation of the video game is interrupted to ensure that the video game does not load default content when suitable alternative content is available. This interruption of the video game is optional if the memory pointer used to select content is changed before any loading of the content. Interrupting the normal operation of the video game is one way to ensure this; however other methods are optionally incorporated instead.

In an alternative to the first embodiment of the invention, the second process identifies the default content and the suitable alternative content. The default content for each suitable alternative content is identified and overwritten with the corresponding suitable alternative content. In this way, the second process is optionally executed prior to normal operation of the video game or during idle time thereof. Clearly, in order to rewrite the default content, it is necessary that the default content be stored in a memory that supports writing thereto.

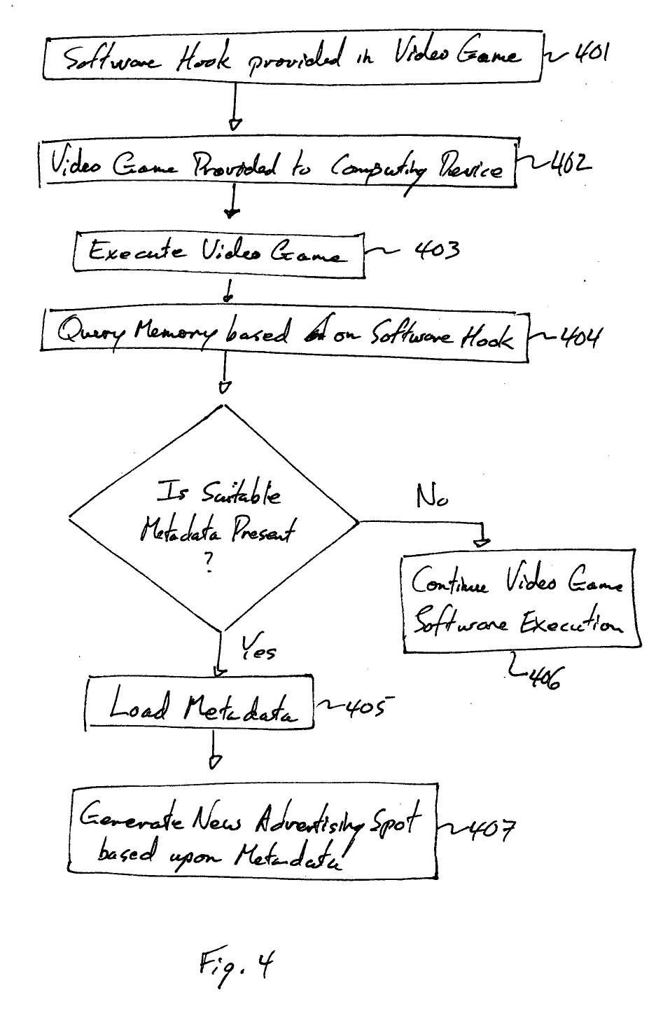

Referring to FIG. 3, a simplified flowchart according to a second embodiment of the invention is shown. A computing device executes game software 301. The computing device also supports a thin client supporting a client memory for storing client content. The game software supports the use of a pointer that describes an address of a memory that is to be retrieved. The computing device also supports a cache memory that stores cache data. During execution of the game software it is determined to be likely that the game software will execute an operation to retrieve data from a specific location 302 within the cache memory and provide it in an input receiver memory, such as a dedicated memory buffer. Once this determination is made the execution of the game software is suspended and the thin client is executed 303. The thin client acts to prevent the game software from loading the data from the memory cache and instead the thin client provides the client content from the client memory to the input receiver memory 304. In addition, the thin client acts to change the operation of the game software such that the game software execution is advanced to a program marker 305 such that the operation to load data from the specific location within the memory cache is skipped. After the thin client has completed these operations the game software continues execution from the program marker 306. In this way, the thin client substitutes data for the default data that would ordinarily by loaded. The thin client is optionally provided after sale of the game software. This is advantageous because thin client comprises both substitution content and the instructions to incorporate the substitution content into the game software. Thus, once the thin client is downloaded and operational no other downloading is needed to present the advertisement. Clearly, the thin client is optionally replaced when it is desired to provide a different advertisement. In fact, this operation is performable by the thin client itself. Alternatively, the advertisement data within the thin client is rewritten to provide a new advertisement. A person of skill in the art will appreciate that a variety of thin clients are optionally provided for use in single video game where each of the thin clients is for providing different content in a different portion of a virtual environment provided by the video game.

In a third embodiment of the invention, a video game is produced without any advertising spots designated. The video game includes a code corresponding to a set of functions that support the delivery of advertising to designated advertising spots. A game developer designing a game suitable for use with the third embodiment of the invention provides software instructions corresponding to a software hook. The software hook acts to recognize metadata in a predetermined cache. When the software program finds the metadata via the software hook, the metadata is used to create a new advertising spot based on an existing asset within the cache.

In use, a software designer producing a video game decides that it would be beneficial to support downloadable advertisements within the video game. Unfortunately, the software designer does not have sufficient resources available to define a variety of locations and other parameters of advertisements. With this in mind, the software designer adds a software hook to the video game. Later, after release of the video game, it is determined that it would be beneficial to provide advertisements within the video game. The software designer produces a file comprising metadata. Typically, the metadata comprises information relating to a virtual environment of the video game. This information is used to define a set of existing assets within the game and to associate external data with those assets. Using the metadata, a specific location is defined as being suitable for receiving and presenting an advertisement content. Optionally, the metadata comprises information relating to a memory location where suitable advertising content is available. Alternatively, the metadata is provided along with suitable advertising content. Thus, while the video game does not directly support advertising spots, the video game is programmed to receive data in a specific form that allows it to easily incorporate advertisements. Optionally, the metadata is used to provide information separate from a virtual environment of the video game, for example in an image that is provided when the video game is loading data and gameplay is interrupted. Alternatively the metadata is used to provide new sounds in the video game. Of course, when the hooks support communication with an external server, the entire process is automatable with little or no effort during design. This allows game providers to monetise on games that are successful after their release without spending upfront to implement in game advertising features.

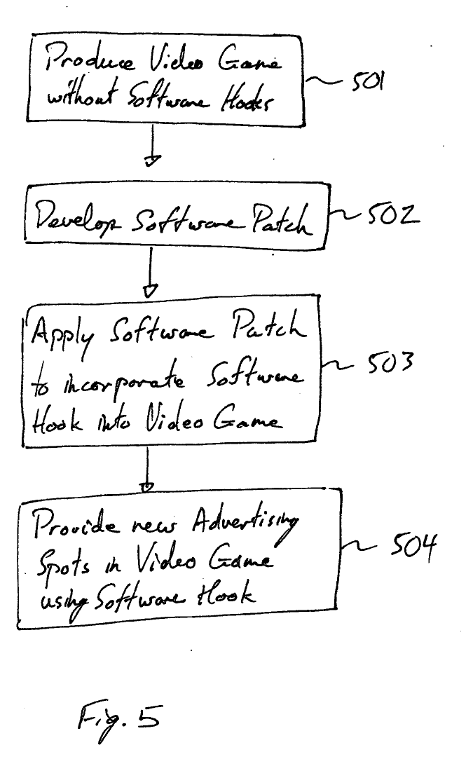

Referring to FIG. 4 a flowchart consistent with a method according to a third embodiment is shown. In use, a game programmer provides a software hook within video game software 401. The video game software is executed within a computing device suitable for executing the software 402. The video game software is run 403. During execution of the video game the software hook is reached. The video game software then queries a memory location in dependence upon the software hook 404. If the memory location contains suitable metadata then the metadata is loaded 405. If no metadata is present then the video game software continues execution 406. The metadata is available then it is used to generate a new advertising spot within the video game 407. Optionally, the memory location is a memory location external to the system in execution of the video game software. Video game software execution then proceeds normally. Thus, when metadata is provided advertising spots are optionally created. A a well designed software hook that is used for incorporating metadata in a video game is ideally standard software code that is supported by a set of standard functions. Preferably, these standard functions are provided within an application programming interface (API.) The memory location is optionally present on a computing device external to the computing device that is executing the gaming session. Thus, the software hook optionally checks an external media server when the computing device supports a data communications connection to a public network. In the event that the computing device is unable to establish communications with the media server then the software hook is inactive. Alternatively, the software hook supports instructions to attempt to establish communications with an external media server, and failing to do so, the software hook attempts to load metadata from a predetermined memory location of a memory directly accessible to the computing device. In the event that the predetermined memory location does not contain the desired metadata, the software hook is made inactive and the video game continues normal execution.

Referring to FIG. 5, a flowchart of a fourth embodiment is shown. A software developer produces a release version of a game program 501. The release version of the game program does not have advertising spots. After the release version of the game program is sold, the software developer decides that it would be advantageous to support dynamic advertising in the game program. In order to provide such functionality the game developer produces a software patch 502. The software patch, when executed, modifies the release version of the game program resulting in a patched version of the game program 503. The patched version of the game program incorporates a software hook as described with reference to the third embodiment of the invention. The software hook is then used to manipulate game assets for the purpose of adding new advertising spots in the patched version of the game program 504. A person of skill in the art will appreciate that in some cases patching video game software is not a desirable option. For example, video games produced for game consoles are typically licensed and approved by the manufacturer of the game console before they are made available for sale. When the game developer wishes to provide a software patch for a console video game, the console manufacturer reviews the patched version of the video game for approval. Many game console units do not support large non-volatile storage media and therefore patching some console video games is simply not practical.

The various embodiments of the invention are optionally used to provide advertising content in portions of the video game that are not specific to a virtual environment. For example, video games often provide a splash screen when they are loading data. Clearly, it is a straight forward to substitute new image data to provide an alternative splash screen using any of the aforementioned embodiments of the invention.

Optionally, the methods described herein are used to modify other assets within a game such as background music, background screens, to customize a user interface of the game, to provide additional content, etc.

Further, the aforementioned embodiments of the invention are also suitable for providing downloaded media where no media was previously presented within the video game. For example, in a virtual environment, a gamer instructs an avatar to enter a restaurant and order a food item. When the game is programmed, the restaurant is generic and the any dialog between the avatar and virtual staff of the restaurant is minimal and generic. Additional dialog within the game is optionally added to the game where the additional dialog is consistent with trademark or slogan of a real restaurant. For example, consider a restaurant advertising campaign that involves a television advertisement in which a restaurant manager says, “It was great to see you today”, when a patron leaves the restaurant. This departure is used as a trademark slogan for the restaurant. In a video game, an action corresponding to a gamer instructing an avatar to leave a restaurant results in the same trademark slogan being heard when the gamer passes by a suitable virtual restaurant staff member. Clearly, a wide variety of other advertisements are optionally provided in which the advertisement is not a substitution of other content but a response to a specific set of interactions within the virtual environment. In another example, in a virtual car race an announcer optionally mentions the brand of car that has won the race. Such a message is optionally provided in a video game that does not ordinarily feature such an announcement. Further, this announcement is optionally provided independent of the actions of the gamer.

A person of skill in the art will appreciate that numerous other embodiments of the invention are apparent without departing from the spirit and scope of the invention.

What is claimed is:

1. A method comprising:
providing a first video game in execution, the video game other than supporting dynamic in game advertising; and,
changing video game content of the first video game during execution thereof in order to provide in game advertising within the first video game in execution

2. A method according to claim 1 wherein the video game content is changed by modifying a content of the video game cache to substitute advertising content for video game content.

3. A method according to claim 1 wherein the video game content is changed by intercepting data during retrieval thereof and substituting same with advertising content.

4. A method according to claim 1 wherein the video game content is changed by modifying instruction codes therein to support in game advertising, the instructions modified in a temporary fashion and other than with a patch.

5. A method according to claim 1 comprising
providing a processor having the first video game in execution thereon;
providing a thin client in execution by the processor and for changing the video game content.

6. A method according to claim 5 comprising:
suspending execution of the first video game while the thin client software is executed; and,
resuming execution of the first video game upon suspension of the execution of the thin client.

7. A method according to claim 5 wherein the thin client is also for communicating with a server via a network to download advertising content therefrom.

8. A method according to claim 7 wherein the thin client is also for communicating with a server via a network to report advertising impression metrics thereto.

9. A method according to claim 8 wherein the thin client in execution executes instructions for:
identifying an occurrence of a specific game event; and,
in response to the occurrence changes the video game content.

10. A method according to claim 5 wherein the thin client in execution executes instructions for:
identifying an occurrence of a specific game event; and,
in response to the occurrence changes the video game content.

11. A method according to claim 5 wherein the thin client in execution executes instructions for:
loading software from the server and using the software to modify the thin client.

12. A method comprising:
executing a video game to provide a video game session supporting a virtual environment with a computing device;
loading thin client within a same computing device;
identifying an occurrence of a predetermined game event; and,
executing thin client in response to the identified occurrence, the thin client for impressing media upon a gamer.

13. A method according to claim 12 comprising:
establishing a data communications path between the thin client and a server via a public network; and,
using the thin client, downloading media data corresponding to the media, the media data downloaded to the computing device via the public network.

14. A method according to claim 1 wherein, the predetermined occurrence comprises an attempt to display of an asset within the virtual world of the video game, the asset comprising default content associated therewith.

15. A method according to claim 14 wherein the default content is stored within a cache.

16. A method according to claim 1 wherein, the predetermined occurrence comprises an attempt to display of an asset within the virtual world of the video game.

17. A method according to claim 16 comprising:
upon identifying the occurrence, querying a remote server for media data corresponding to the media;
when the media data is other than available, providing the default content; and,
when the media data is available, providing the media and other than providing the default content.

18. A method according to claim 17 wherein when the media data is available, the media data is stored within a cache of the video game in execution.

19. A method comprising:
providing a computing device;
loading a thin client;
loading alternative advertising content;
loading video game software, the video game software for supporting a video game session;
identifying at least an instance of an advertising spot within the video game session;
for each identified instance of an advertising spot identifying a memory location associated with default content associated with the advertising spot;
for each identified instance reviewing the alternative advertising content to determine if advertising content is available; and,
when advertising content is available writing the advertising content in place of the default content.

20. A method according to claim 19 comprising:
establishing a data communications path between the computing device and an external server via a public network; and,
downloading the thin client to the computing device from the external server via the public network; and,
downloading the alternative advertising content to the computing device from the external server via the public network.

21. A method according to claim 20 comprising:
receiving an input signal from a gamer to the computing device, the input signal for executing the video game software; and,
upon receiving the input signal, executing the thin client.

22. A method comprising:
providing a computing device;
providing a game program;
executing the game program using the computing device, the game program comprising a software hook for obtaining metadata, the game program for providing a virtual environment;
obtaining metadata using the software hook; and,
in accordance with the metadata, providing an advertising spot within the virtual environment.

23. A method according to claim 22 comprising:
establishing a data communication path between the computing device and an external server via public network, and wherein obtaining metadata comprises obtaining metadata from the external server via the public network.

24. A method according to claim 23 comprising:
receiving advertisement data from the public network;
storing advertisement data on the computing device;
providing advertising media corresponding to the advertising data, the advertising media provided in accordance with the advertising spot.

25. A method according to claim 22 wherein providing a game program comprises:
providing an unpatched game program, the unpatched game program other than comprising the software hook and, when executed, being unsuitable for obtaining metadata;
providing patch software;
executing the patch software on the unpatched game program and thereby providing the game program.

26. A method according to claim 25 comprising:
establishing a data communication path between the computing device and an external server via public network, and wherein obtaining metadata comprises obtaining metadata from the external server via the public network.

27. A method according to claim 26 comprising:
receiving advertisement data from the public network;
storing advertisement data on the computing device;
providing advertising media corresponding to the advertising data, the advertising media provided in accordance with the advertising spot.

28. A storage medium comprising data stored therein, the data for when executed resulting in execution of:
detecting a first video game in execution, the video game other than supporting dynamic in game advertising; and,
changing video game content of the first video game during execution thereof in order to provide in game advertising within the first video game in execution.

29. A storage medium comprising data stored therein, the data for when executed resulting in execution of:
providing a computing device;
providing a game program;
executing the game program using the computing device, the game program comprising a software hook for obtaining metadata, the game program for providing a virtual environment;
obtaining metadata using the software hook; and,
in accordance with the metadata, providing an advertising spot within the virtual environment.
